(19) United States
(12) Patent Application Publication
(10) Pub. No.: US 2013/0222789 A1
(43) Pub. Date: Aug. 29, 2013

(54) SPECTROPHOTOMETER

(71) Applicants: Shigeru Matsui, Hitachinaka (JP); Shuhei Yamamura, Hitachinaka (JP); Hideyuki Akiyama, Hitachinaka (JP); Yoshisada Ebata, Hitachinaka (JP)

(72) Inventors: Shigeru Matsui, Hitachinaka (JP); Shuhei Yamamura, Hitachinaka (JP); Hideyuki Akiyama, Hitachinaka (JP); Yoshisada Ebata, Hitachinaka (JP)

(21) Appl. No.: 13/879,816

(22) PCT Filed: Nov. 14, 2011
(86) PCT No.: PCT/JP2011/076180

§ 371 Date: Apr. 17, 2013

(30) Foreign Application Priority Data
Nov. 19, 2010 (JP) 2010 259253

(51) Int. Cl. G01J 3/42

(52) U.S. Cl. CPC G01J 3/42
USPC 356/51; 356/319

(57) ABSTRACT

In a spectrophotometer of the single-beam type, highly stable transmission and absorption spectra can be obtained with a high SNR while drifting is suppressed and for a long time even when the amount of light from the light source is varied over time. The spectrophotometer includes: a light source; a sample cell; a polychromator that generates a transmission spectrum of a sample in the sample cell by dispersing a portion of light from the light source that has passed through the sample into a plurality of spectral components; an image sensor that detects the transmission spectrum of the sample; a light source monitoring photodetector that detects a portion of the light from the light source that has not passed through the sample cell; and an operation unit that corrects the transmission spectrum of the sample by using an output signal from the light source monitoring photodetector.

### TECHNICAL FIELD

The present invention relates to a spectrophotometer for measuring the transmission spectrum or absorption spectrum of a sample, particularly to a spectrophotometer of the single-beam type.

### BACKGROUND ART

Conventionally, as a spectrophotometer for measuring a transmission spectrum or an absorption spectrum, a spectrophotometer of the so-called double-beam type is known. In the spectrophotometer of the double-beam type, two cells of a sample cell and a reference cell are provided, the amount of light that has passed through each cell is measured, and the transmission spectrum is obtained by determining the ratio of the respective amounts of light. Further, through logarithmic transformation of the ordinate axis of the transmission spectrum, the absorption spectrum can be obtained. Because a light beam for the sample cell and a light beam for the reference cell are measured simultaneously in the spectrophotometer of the double-beam type, the advantage can be obtained that a correct transmission spectrum of the sample can be obtained even when the amount of light from a light source is varied over time.

JP Patent Publication (Kokai) Nos. 59-230124 A (1984) and 63-198832 A (1988) describe examples of the spectrophotometer of the double-beam type using an image sensor. The spectrophotometer of the double-beam type using an image sensor has the problem that the structure is complex, the volume is increased, and the manufacturing cost is high. Thus, a spectrophotometer equipped with an image sensor generally employs a single-beam type.

JP Patent Publication (Kokai) No. 11-108830A (1999) describes an absorbance measurement apparatus of the single-beam type such that light from a light source is dispersed spectrally by a dispersive element and the dispersed light is detected by an array-type photodetector.

Further, JP Patent Publication (Kokai) No. 61-53527A (1986) describes a spectrophotometer equipped with two types of light sources, one a deuterium lamp for an ultraviolet region and the other a halogen lamp for a visible region.

### PATENT DOCUMENTS

Patent Document 1: JP Patent Publication (Kokai) No. 59-230124 A (1984)

Patent Document 2: JP Patent Publication (Kokai) No. 63-198832 A (1988)

Patent Document 3: JP Patent Publication (Kokai) No. 11-108830 A (1999)

Patent Document 4: JP Patent Publication (Kokai) No. 61-53527 A (1986)

### SUMMARY OF THE INVENTION

### Problem to be Solved by the Invention

The spectrophotometer of the single-beam type has the advantage of simplified structure, smaller volume, and lower manufacturing cost, for example. However, with the spectrophotometer of the single-beam type, it is difficult to obtain the correct transmission spectrum of the sample when the amount of light from the light source is varied over time.

An object of the present invention is to enable the acquisition of highly stable transmission and absorption spectra with a high SNR in a spectrophotometer of the single-beam type while drifting is suppressed for a long time even when the amount of light from a light source is varied over time.

### Means for Solving the Problem

According to the present invention, a spectrophotometer includes a light source; a sample cell; a polychromator that generates a transmission spectrum of a sample in the sample cell by dispersing a portion of light from the light source that has passed through the sample cell into a plurality of spectral components; an image sensor that detects the transmission spectrum of the sample; a light source monitoring photodetector that detects a portion of the light from the light source that has not passed through the sample cell; and an operation unit that corrects the transmission spectrum of the sample by using an output signal from the light source monitoring photodetector.

The operation unit performs correction by dividing the transmission spectrum by a correction coefficient that is determined from the output signal from the light source monitoring photodetector.

### Effects of the Invention

According to the present invention, in a spectrophotometer of the single-beam type, highly stable transmission and absorption spectra can be obtained with a high SNR and for a long time while drifting is suppressed even when the emission intensity of the light source is varied over time.

### BRIEF DESCRIPTION OF DRAWINGS

FIG. 1 illustrates the configuration of a first example of a spectrophotometer according to the present invention.

FIG. 2 illustrates an example of the wavelength spectra of emission intensity of a halogen lamp and a deuterium lamp.

FIG. 3 illustrates temporal variations in the emission intensity of the halogen lamp and the deuterium lamp.

FIG. 4A is another figure illustrating the temporal variation in the emission intensity of the halogen lamp and the deuterium lamp.

FIG. 4B is another figure illustrating the temporal variation in the emission intensity of the halogen lamp and the deuterium lamp.

FIG. 5 illustrates the configuration of a second example of the spectrophotometer according to the present invention.

FIG. 6 is a partial enlarged view of the second example of the spectrophotometer according to the present invention.

### MODE FOR CARRYING OUT THE INVENTION

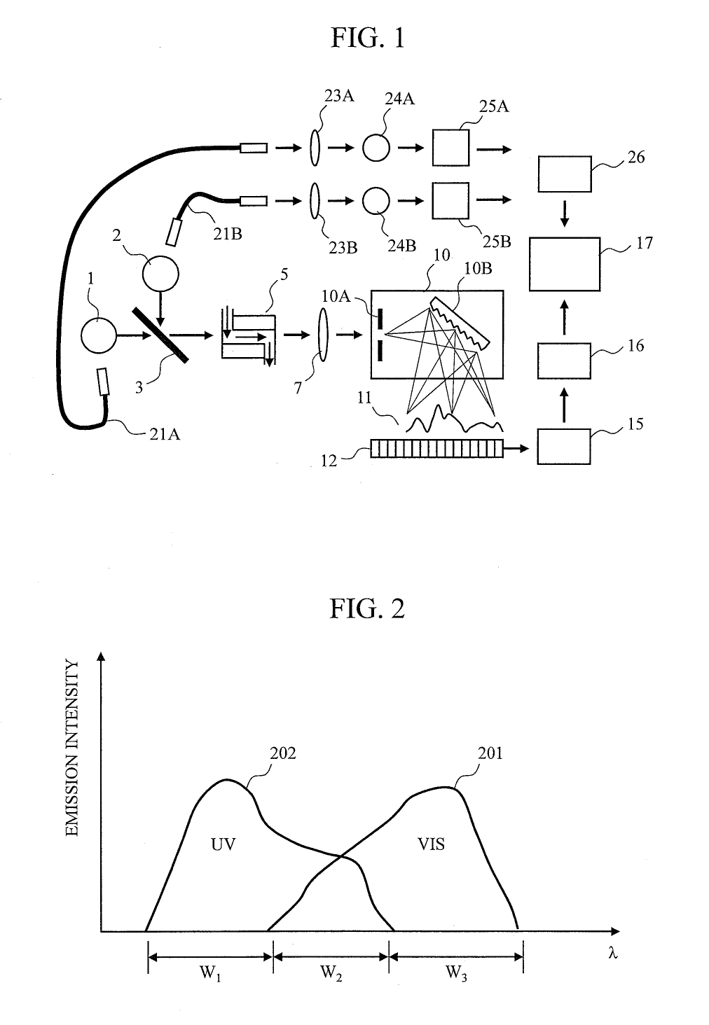

With reference to FIG. 1, a first example of a spectrophotometer according to the present invention will be described. The spectrophotometer according to the present example includes a first and a second light sources 1 and 2, a sample cell 5, detection optics, a detection optics operation unit, light source monitoring optics, a light source monitoring system operation unit, and a computer 17. The detection optics include a dichroic mirror 3, an imaging lens 7, a polychromator 10, and a one-dimensional image sensor 12. Instead of the one-dimensional image sensor 12, a two-dimensional image sensor may be used. The detection optics operation unit includes an amplifier 15 and an A/D converter 16.

The light source monitoring optics include a first and a second optical fibers 21A and 21B, a first and a second lenses 23A and 23B, and a first and a second light source monitoring photodetectors 24A and 24B. The optical fibers 21A and 21B may be optical fiber bundles. The light source monitoring optics operation unit includes a first and a second amplifiers 25A and 25B, and an A/D converter 26.

The first light source 1 is a light source for a longer wavelength region, while the second light source 2 is a light source for a shorter wavelength region. In the present example, a halogen lamp for a visible region is used for the first light source 1, and a deuterium lamp for an ultraviolet region is used for the second light source 2. The sample cell 5 may include a sample cell with a structure adapted to various kinds of samples, such as solids, liquids, and gases. In the illustrated example, the sample cell 5 is a flow cell for liquid samples. A sample flows along the optical axis of the detection optics, as indicated by arrows. The flow cell can be suitably used as a liquid chromatograph detector.

First, the detection optics and the detection optics operation unit will be described. Light outputted from the first and the second light sources 1 and 2 is combined by the dichroic mirror 3 and then enters the sample cell 5. The light that has passed through the sample cell 5 is collected by the imaging lens 7, and then enters the polychromator 10. The polychromator 10 includes an entrance slit 10A and a spectral dispersive element 10B. The spectral dispersive element 10B may be a diffraction grating. The incident light that has passed through the entrance slit 10A is dispersed spectrally by the spectral dispersive element 10B, whereby a transmission spectrum image 11 is formed on an exit-side focal plane. The transmission spectrum image 11 represents the spectral transmission characteristics of the liquid sample in the sample cell 5. The transmission spectrum image 11 is converted by the one-dimensional image sensor 12 into an electric signal for each spectral region. The electric signal is amplified by the amplifier 15 and then converted into a digital signal by the A/D converter 16. The digitally converted signal of the transmission spectrum is stored in a memory of the computer 17. By subjecting the transmission spectrum to logarithmic transformation, an absorption spectrum can be obtained.

Next, the light source monitoring optics and the light source monitoring system operation unit will be described. The light outputted from the first and the second light sources 1 and 2 is guided via the first and the second optical fibers 21A and 21B to the first and the second lenses 23A and 23B, respectively, by which the light is respectively collected. The collected light is respectively detected by the first and the second light source monitoring photodetectors 24A and 24B and converted into electric signals. The electric signals are amplified by the first and the second amplifiers 25A and 25B, respectively, and converted by the A/D converter 26 into respective digital signals. The digitally converted detection signals are stored in the memory of the computer 17.

An entrance-side end surface of the first optical fiber 21A is disposed in the vicinity of the first light source 1. Thus, only some of the emission from the first light source 1 is acquired via the entrance-side end surface of the first optical fiber 21A. An entrance-side end surface of the second optical fiber 21B is disposed in the vicinity of the second light source 2. Thus, only some of the emission from the second light source 2 is acquired via the entrance-side end surface of the second optical fiber 21B. The optical fibers 21A and 21B are disposed such that the optical fibers 21A and 21B do not interfere with the optical paths from the two light sources 1 and 2 to the sample cell 5.

The entrance ends of the first and the second optical fibers 21A and 21B are disposed such that the emission from the second light source 2 is not detected by the first optical fiber 21A and the emission from the first light source 1 is not detected by the second optical fiber 21B.

Further, the first optical fiber 21A is disposed such that exit light from the exit-side end surface of the first optical fiber 21A enters the first light source monitoring photodetector 24A via the first lens 23A. The second optical fiber 21B is disposed such that exit light from the exit-side end surface of the second optical fiber 21B enters the second light source monitoring photodetector 24B via the second lens 23B.

First, blank correction will be described. In the intensity distribution of the transmission spectrum image 11 obtained by the one-dimensional image sensor 12, not only the spectral transmission characteristics of the sample in the sample cell 5 but also optical properties due to the apparatus, such as the spectral emission characteristics of the light sources 1 and 2 and the spectral efficiency characteristics of the polychromator 10, are reflected. Such optical properties due to the apparatus need to be removed from the intensity distribution of the transmission spectrum image 11.

First, a transmission spectrum image is acquired without the flow of a sample in the sample cell 5. “Without the flow of a sample in the sample cell 5” may include the flow of pure water or a blank sample. The acquired transmission spectrum image is stored in the memory of the computer 17 as a reference transmission spectrum. The reference transmission spectrum represents the optical properties due to the apparatus.

Then, a transmission spectrum image is acquired with the flow of a sample as the object of analysis in the sample cell 5, and the acquired transmission spectrum image is stored in the memory of the computer 17 as the transmission spectrum of the sample. The transmission spectrum of the sample includes both the spectral transmission characteristics of the sample and the optical properties due to the apparatus.

In the transmission spectrum, the optical properties due to the apparatus are reflected in the form of multiplication. Thus, in order to remove the influence of the optical properties due to the apparatus, the optical properties due to the apparatus may be divided. Namely, the intensity of each wavelength in the transmission spectrum of the sample may be divided by the intensity of the corresponding wavelength in the reference transmission spectrum. In this way, the transmission spectrum of the sample from which the optical properties due to the apparatus have been removed can be obtained.

Blank correction for the absorption spectrum is performed as follows. Through logarithmic transformation of the reference transmission spectrum and the transmission spectrum of the sample, a reference absorption spectrum and a sample absorption spectrum are obtained. In the absorption spectra, the optical properties due to the apparatus are reflected in the form of addition. Thus, in order to remove the influence of the optical properties due to the apparatus, the optical properties due to the apparatus may be subtracted. Namely, the intensity of each wavelength in the absorption spectrum of the sample may be subtracted by the intensity of the corresponding wavelength in the reference absorption spectrum. In this way, the absorption spectrum from which the optical properties due to the apparatus have been removed can be obtained.

Of the optical properties due to the apparatus, the spectral emission characteristics of the light sources 1 and 2 are varied when the emission intensity of the light sources 1 and 2 is varied. Thus, the reference transmission spectrum is varied when the emission intensity of the light sources 1 and 2 is varied. Because the spectrophotometer of the present example is of the single-beam type, there is a discrepancy between the time of acquisition of the reference transmission spectrum and the time of acquisition of the sample transmission spectrum. If the emission intensity of the light sources 1 and 2 is varied during the acquisition times of the two transmission spectra, an error is caused in the transmission spectrum. In order to avoid this, the reference transmission spectrum may be acquired as needed so that the latest reference transmission spectrum can be used at all times.

When the sample cell 5 is a flow cell, an analysis may be conducted to determine how the component concentration or composition ratio of the liquid flowing in the flow cell varies in a predetermined time. In such a case, the reference transmission spectrum cannot be acquired as and when needed.

Thus, according to the present invention, after the blank correction, light amount correction is implemented. As will be described in detail below, the emission intensity of the light sources 1 and 2 is measured using the light source monitoring optics, and the transmission spectrum and the absorption spectrum are corrected accordingly.

FIG. 2 illustrates an example of the emission intensity spectra of the halogen lamp and the deuterium lamp, in which the ordinate axis shows the emission intensity and the abscissa axis shows the wavelength. A curve 201 indicates the emission spectrum of the halogen lamp, and a curve 202 indicates the emission intensity spectrum of the deuterium lamp. The halogen lamp emits light in the visible region, while the deuterium lamp emits light in the ultraviolet region. However, the spectral regions of the light from the two lamps are partly overlapped. Thus, three spectral regions W₁, W₂, and W₃ are set along the abscissa axis. The first spectral region W₁ is a region in which there is only the emission from the deuterium lamp. The second spectral region W₂ is a region in which the emissions from the two lamps are overlapped. The third region W₃ is a region in which there is only the emission from the halogen lamp.

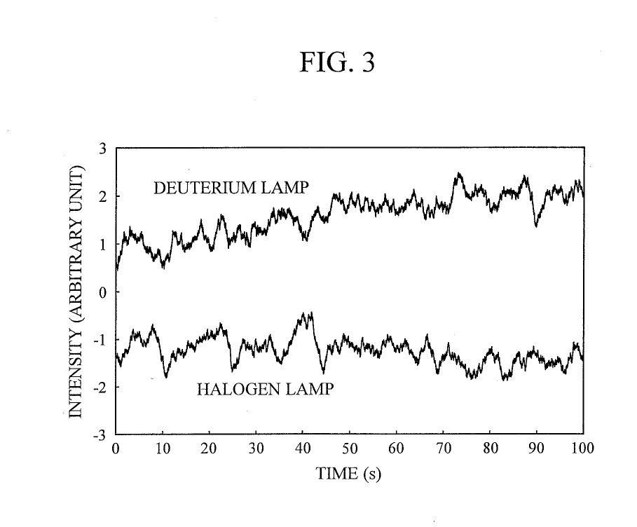

FIG. 3 illustrates an example of the temporal change characteristics of the emission intensity of the halogen lamp and the deuterium lamp. As seen from FIG. 3, there is not much correlation between the temporal variation for the halogen lamp and the temporal variation for the deuterium lamp.

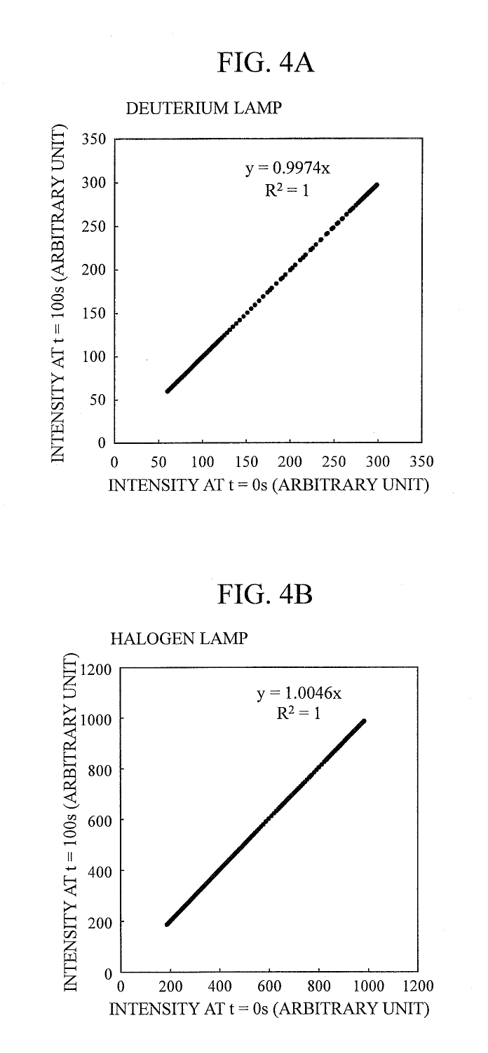

FIG. 4A illustrates the correlation between the emission intensity of the light from the deuterium lamp at the start of measurement and the emission intensity 10 minutes later. The abscissa axis shows the emission intensity for each wavelength at the start of measurement, and the ordinate axis shows the emission intensity for each wavelength 10 minutes after the start of measurement. FIG. 4B illustrates the correlation between the emission intensity of the light from the halogen lamp at the start of measurement and the emission intensity 10 minutes later. The abscissa axis shows the emission intensity for each wavelength at the start of measurement, and the ordinate axis shows the emission intensity for each wavelength 10 minutes after the start of measurement. It will be seen that, although slight variations that differ depending on the wavelength are observed between the emission intensity at the start of measurement and the emission intensity 10 minutes later in both lamps, the major portion of the amount of variation constitutes a component that varies at a common ratio not depending on the wavelength.

From the graphs of FIGS. 4A and 4B, it can be seen that a large improvement effect can be obtained by determining a single correction value by consolidating the emission intensities in a wide spectral region of each light source, and correcting the amount of light with which the sample is irradiated on the basis of the correction value for each wavelength.

In the following, light amount correction for the spectrophotometer according to the present example will be described. First, for simplicity, a case where only the halogen lamp, i.e., the first light source 1 of the two light sources, is used will be described. It is supposed that the reference transmission spectrum is acquired at time t =0 and that thereafter the transmission spectrum S(λ, ti)(λ is the wavelength) of the sample is acquired at time t=ti (i=1, 2, 3, . . . ). The emission intensity of the halogen lamp at time t=0 and t=ti (i=1, 2, 3, . . . ) is H(0) and H(ti), respectively. By using the reference transmission spectrum, blank correction for the transmission spectrum of the sample is performed as described above. Further, light amount correction is performed on the transmission spectrum of the sample after blank correction. In the transmission spectrum, the light amount variation of the light source is reflected in the form of multiplication. Thus, in order to remove the influence of the light amount variation of the light source, the intensity of each wavelength in the transmission spectrum of the sample may be divided by a correction coefficient a, which represents the light amount variation of the light source. The transmission spectrum S′(λ, ti) of the sample after correction can be determined by the following expression.

S′(λ, ti)=S(λ, ti)/α=S(λ, ti)/(H(ti)/H(0)) (1)

S(λ, ti) is the transmission spectrum of the sample after blank correction, and S′(λ, ti) is the transmission spectrum of the sample after light amount correction. The terms H(0) and H(ti) in the right-hand side of expression (1) represent an output signal from the first light source monitoring photodetector 24A, respectively. The denominator α=H(ti)/H(0) in the right-hand side of the expression is the correction coefficient.

As expressed by expression (1), time t=ti (i=1, 2, 3, . . . ) indicates the time interval for acquiring the transmission spectrum of the sample. In the present example, the time interval for monitoring the light amount variation of each lamp is equal to the time interval for acquiring the transmission spectrum of the sample. However, the time interval for monitoring the light amount variation of each lamp may be set at an appropriate interval with respect to the temporal variation characteristics of each lamp.

In the present example, the case in which only the halogen lamp is used has been described. However, the same may apply when instead of the halogen lamp only the deuterium lamp is used. Also, the same may apply to a system in which the emission of the two lamps is switched temporally. Further, the same may apply for measurement in the first spectral region W₁ with the emission only from the deuterium lamp, or in the third region W₃ with the emission only from the halogen lamp in FIG. 2.

Next, a case is considered in which, as in the example of FIG. 1, the emissions from the two lamps are combined by the dichroic mirror so that the sample is irradiated at all times with the emissions from both of the light sources simultaneously. This corresponds to the measurement in the second spectral region W₂ in FIG. 2 in which the spectral regions of the two lamps of the deuterium lamp and the halogen lamp are overlapped.

It is assumed that the reference transmission spectrum is acquired at time t=0 and that thereafter the transmission spectrum of the sample S(λ, ti) (λ is the wavelength) is acquired at time t=ti (i=1, 2, 3, . . . ). The emission intensity of the halogen lamp at time t=0 and t=ti is H(0) and H(ti), respectively. The emission intensity of the deuterium lamp at time t=0 and t=ti is D(0) and D(ti), respectively. By using the reference transmission spectrum, blank correction of the transmission spectrum of the sample is performed as described above. Further, light amount correction is performed on the transmission spectrum of the sample after blank correction. In the transmission spectrum, the light amount variation of the light source is reflected in the form of multiplication. Thus, in order to remove the influence of the light amount variation of the light source, the intensity at each wavelength in the transmission spectrum of the sample may be divided by a correction coefficient β representing the light amount variation of the light source. The transmission spectrum of the sample S′(λ, ti) after correction can be determined by the following expression.

S′(λ, ti)=S(λ, ti)/β(λ, ti)/{(H(ti)+D(ti))/(H(0)+D(0))} (2)

S(λ, ti) is the transmission spectrum of the sample after blank correction, and S′(λ, ti) is the transmission spectrum of the sample after light amount correction. The terms H(0) and H(ti) in the right-hand side of expression (2) represent the output signal from the first light source monitoring photodetector 24A, and the terms D(0) and D(ti) in the right-hand side represent the output signal from the second light source monitoring photodetector 24B. The denominator β=(H(ti)+D(ti))/H(0)+D(0)) in the right-hand side of the expression is the correction coefficient.

As indicated by expression (2), the time t=ti (i=1, 2, 3, . . . ) indicates the time interval for acquiring the transmission spectrum of the sample. In the present example, the time interval for monitoring the light amount variation of each lamp is equal to the time interval for acquiring the transmission spectrum of the sample. However, the time interval for monitoring the light amount variation of each lamp may be set at an appropriate interval for the temporal variation characteristics of each lamp.

In the absorption spectrum, the light amount variation of the light source is reflected in the form of addition. Thus, in order to remove the influence of the light amount variation of the light source, the intensity at each wavelength in the absorption spectrum of the sample may be subtracted by a value obtained through logarithmic transformation of the correction coefficients α and β.

In the denominator and numerator for the correction coefficient β in the right-hand side of expression (2), the output signals H(0) and H(ti) from the first light source monitoring photodetector 24A and the output signals D(0) and D(ti) from the second light source monitoring photodetector 24B are added as is. However, the ratio of the output signals from the two detection optics may vary depending on the installed state of the respective optical fibers, the spectral sensitivity characteristics of the photodetectors, and other influences. Thus, of the light that actually enters the sample cell 5, the ratio of the two output signals H(t) and D(t) may not necessarily correctly represent the ratio of the amount of light from the first light source 1 and the amount of light from the second light source 2.

Thus, of the light that actually enters the sample cell 5, the ratio of the amount of light from the first light source 1 and the amount of light from the second light source 2 is measured in advance. One of the output signals H(t) and D(t) of the two detection optics is multiplied by the ratio, k, so that H(t)+D(t) is H(t)+k×D(t) or k×H(t)+D(t). By thus considering the ratio k of the output signals H(t) and D(t) from the two detection optics, the transmission spectrum S′(λ, ti) of the sample after correction can be determined by the following expression.

S′(λ, ti)=S(λ, ti)/{(H(ti)+k×D(ti))/H(0)+k×D(0))} (3)

When k=1, expression (3) is the same as expression (2). Thus, according to the present example, a highly stable spectrum in which the influence of the light amount variation is corrected can be measured even when the emission intensity of the light sources is varied over time.

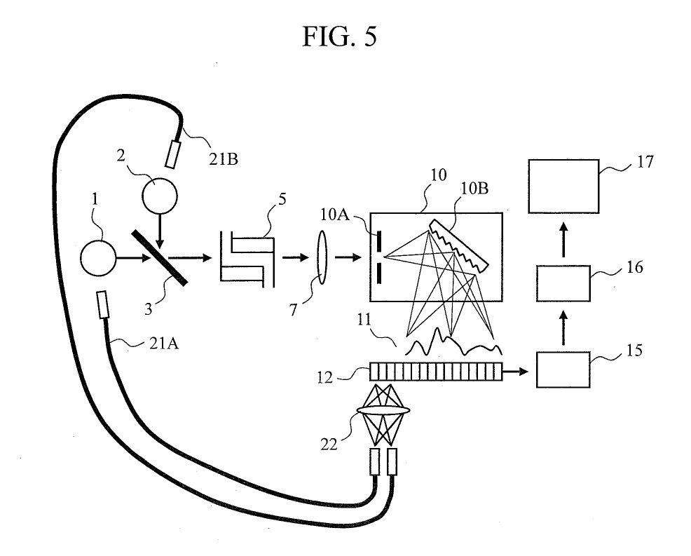

With reference to FIG. 5, a second example of the spectrophotometer according to the present invention will be described. The spectrophotometer includes the first and the second light sources 1 and 2, the sample cell 5, the detection optics, the detection optics operation unit, the light source monitoring optics, and the computer 17. Compared to the first example illustrated in FIG. 1, the spectrophotometer according to the present example differs in the configuration of the light source monitoring optics. The present example also differ in that the light source monitoring optics operation unit is omitted and the detection optics operation unit is used instead thereof.

In the following, the configuration of the light source monitoring optics will be described while the description of the detection optics and the detection optics operation unit is omitted. The light source monitoring optics include the first and the second optical fibers 21A and 21B, and a lens 22. In the spectrophotometer of the present example, the one-dimensional image sensor 12 is used by both the detection optics and the light source monitoring optics.

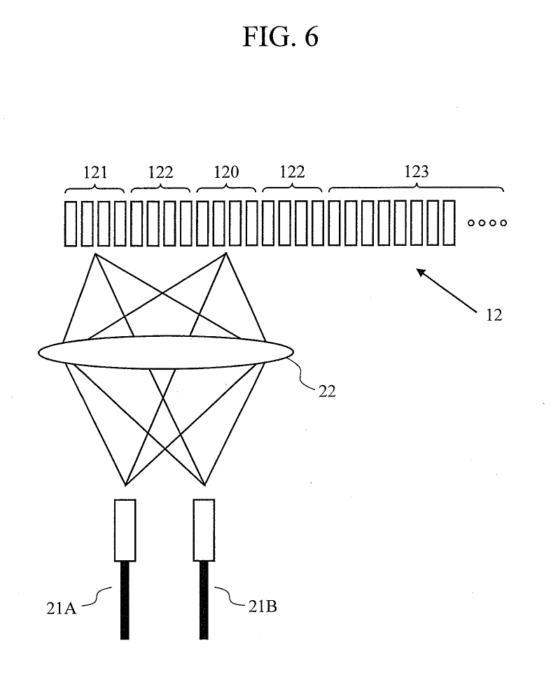

With reference to FIG. 6, a method for using the one-dimensional image sensor 12 according to the second example of the spectrophotometer of the present invention will be described. In the illustrated example, the one-dimensional image sensor 12 has 1024 pixels in a light receiving surface thereof. Of the 1024 pixels, four pixels are used as a second light source monitoring pixel 121; four pixels adjacent thereto are used as a separation pixel 122; four pixels adjacent thereto are used as a first light source monitoring pixel 120; four pixels adjacent thereto are used as a separation pixel 122; and the remaining pixels 123 are used as a detection optics pixel 123. The first and second light source monitoring pixels 120 and 121 include the function of the first and the second light source monitoring photodetectors 24A and 24B, respectively, of the first example of the spectrophotometer illustrated in FIG. 1.

Generally, the pitch of the one-dimensional image sensor 12 in the direction in which the pixels are arranged may be on the order of approximately 25 micrometer. Compared to the distance between the two light source monitoring photodetectors 24A and 24B according to the first example illustrated in FIG. 1, the distance between the two light source monitoring pixels 120 and 121 is smaller. Thus, the exit light from the exit-side end surface of the two optical fibers 21A and 21B is collected by the common lens 22 such that a reduced image is formed on the two light source monitoring pixels 120 and 121.

The separation pixel 122 is provided between the two light source monitoring pixels 120 and 121 so as to prevent crosstalk between the optical signals or electric signals from the light source monitoring pixels 120 and 121. The separation pixel 122 is provided between the first light source monitoring pixels 120 and the detection optics pixel 123 so as to prevent crosstalk between the optical signals or electric signals from the first light source monitoring pixel 120 and the detection optics pixel 123.

In the present example, a sum of the output signals from the four pixels of the first light source monitoring pixel 120 provides H(t) of expression (2), and a sum of the output signals from the four pixels of the second light source monitoring pixel 121 provides D(t) of expression (2). In the present example too, the method of correcting the light amount variation of the first and the second light sources 1 and 2 may be the same as that for the first example. Thus, the description of the method will be omitted.

In the present example, as an effect similar that of the first example, a highly stable spectrum in which the influence of light amount variation has been corrected can be measured even when the emission intensity of the light sources is varied over time. Further, according to the present example, the light source monitoring optics and the operation unit, which are required in the first example, can be eliminated, so that a low-cost and space-saving apparatus can be provided.

While in the present example four pixels are used as the two light source monitoring pixels 120 and 121, the number of the pixels may be increased or decreased as needed so as to obtain an SNR necessary for the above correction calculations.

While examples of the present invention have been described, it should be readily understood by those skilled in the art that the present invention is not limited to the foregoing examples and that various modifications may be made within the scope of the invention described in the claims.

### REFERENCE SIGNS LIST

1, 2 Light source
3 Dichroic mirror
5 Sample cell
7 Imaging lens
10A Entrance slit
10 Polychromator
11 Transmission spectrum image
12 Image sensor
15 Amplifier
16 A/D converter
17 Computer
21A, 21B Optical fiber
22, 23A, 23B Lens
24A, 24B Light source monitoring photodetector
25A, 25B Amplifier
26 A/D converter
120, 121 Light source monitoring pixel
122 Separation pixel
123 Detection optics pixel

1. A spectrophotometer comprising:
a light source;
a sample cell;
a polychromator that generates a transmission spectrum of a sample in the sample cell by dispersing a portion of light from the light source that has passed through the sample cell into a plurality of spectral components;
an image sensor that detects the transmission spectrum of the sample;
a light source monitoring photodetector that detects a portion of the light from the light source that has not passed through the sample cell; and
an operation unit that corrects the transmission spectrum of the sample by using an output signal from the light source monitoring photodetector,
wherein the operation unit performs correction by dividing the transmission spectrum by a correction coefficient representing a light amount variation of the light sources that is determined from the output signal from the light source monitoring photodetector.

2. The spectrophotometer according to claim 1, wherein the operation unit determines a transmission spectrum S′(λ, ti)(λ is wavelength) after correction according to the following expression:
S′(λ, ti)=S(λ, ti)/(H(ti)/H(0)) (1)
where H(0) and H(ti) are the emission intensity of the light source time at t=0 and t=ti (i=1, 2, 3, . . . ), respectively, and S(λ, ti) is the transmission spectrum of the sample at time t=ti (i=1, 2, 3, . . . ).

3. The spectrophotometer according to claim 1, wherein a reference transmission spectrum is acquired by the polychromator at time t=0 without a sample as an object of analysis in the sample cell, and the transmission spectrum S(λ, ti)(λ is wavelength) of the sample at time t=ti (i=1, 2, 3, . . . ) is corrected by using the reference transmission spectrum.

4. The spectrophotometer according to claim 1, further comprising an optical fiber for guiding the portion of the light from the light source that has not passed through the sample cell to the light source monitoring photodetector.

5. The spectrophotometer according to claim 1, wherein the image sensor includes pixels of which some are used as the light source monitoring photodetector and the other are used as a photodetector for detecting the transmission spectrum of the sample.

6. The spectrophotometer according to claim 5, wherein the pixels of the image sensor include a non-light detecting pixel region disposed between a pixel region used as the light source monitoring photodetector and a pixel region for detecting the transmission spectrum of the sample.

7. The spectrophotometer according to claim 1, wherein the operation unit determines an absorption spectrum through logarithmic transformation of the transmission spectrum, and performs the correction by subtracting the absorption spectrum by the correction coefficient representing the light amount variation of the light source which is determined from a logarithmic transformation value of the output signal from the light source monitoring photodetector.

8. The spectrophotometer according to claim 1, wherein:
the light source includes a first and a second light sources with mutually different emission spectral regions; and
the operation unit determines a transmission spectrum S′(λ, ti)(λ is wavelength) after correction according to the following expression:
S′(λ, ti)=S(λ, ti)/β=S(λ, ti)/{(H(ti)+D(ti))/(H(0)+D(0))} (2)
where: H(0) and H(ti) are the emission intensity of the first light source at time t=0 and t=ti (i=1, 2, 3, . . . ), respectively; D(0) and D(ti) are the emission intensity of the second light source at time t=0 and t=ti, respectively; and S(λ, ti) is the transmission spectrum of the sample at time t=ti (i=1, 2, 3, . . . ).

9. The spectrophotometer according to claim 8, wherein the first light source is a halogen lamp for a visible region, and the second light source is a deuterium lamp for an ultraviolet region.

10. A spectrophotometer comprising:
a first and a second light sources with mutually different emission spectral regions;
a sample cell;
detection optics that generate a transmission spectrum of a sample in the sample cell from a portion of light from the first and the second light sources that has passed through the sample cell;
light source monitoring optics that detect a portion of the light from the first and the second light sources that has not passed through the sample cell; and
an operation unit that corrects the transmission spectrum of the sample by using an output signal from the light source monitoring optics,
wherein the operation unit performs correction by dividing the transmission spectrum by a correction coefficient representing a light amount variation of the light sources that is determined from the output signal from the light source monitoring optics.

11. The spectrophotometer according to claim 10, wherein the operation unit determines a transmission spectrum S′(λ, ti)(λ is wavelength) after correction according to the following expression:
S′(λ, ti)=S(λ, ti)/{(H(ti)+k×D(ti))/(H(0)+k×D(0))} (3)
where H(0) and H(ti) are the emission intensity of the first light source and D(0) and D(ti) are the emission intensity of the second light source at time t=0 and t=ti (i=1, 2, 3, . . . ), respectively; S(λ, ti) is the transmission spectrum of the sample at time t=ti (i=1, 2, 3, . . . ); and k is the ratio of the amount of light from the first light source and the amount of light from the second light source.

12. The spectrophotometer according to claim 10, wherein a reference transmission spectrum is acquired by the detection optics at time t=0 without a sample as an object of analysis in the sample cell, and the transmission spectrum S(λ, ti)(λ is wavelength) of the sample at time t=ti (i=1, 2, 3, . . . ) is corrected by using the reference transmission spectrum.

13. The spectrophotometer according to claim 10, wherein:
the detection optics include a polychromator that generates the transmission spectrum of the sample in the sample cell by dispersing the portion of the light from the first and the second light sources that has passed through the sample cell into a plurality of spectral components, and an image sensor that detects the transmission spectrum of the sample; and
the light source monitoring optics include a first and a second optical fibers that take in the portion of the light from the first and the second light sources that has not passed through the sample cell,
wherein the light taken in by the first and the second optical fibers is detected by the image sensor.

14. The spectrophotometer according to claim 13, wherein the image sensor includes pixels of which some are used as the light source monitoring photodetector and the other are used as a photodetector for detecting the transmission spectrum of the sample.

15. The spectrophotometer according to claim 14, wherein the pixels of the image sensor includes a non-light detecting pixel region disposed between a pixel region used as the light source monitoring photodetector and a pixel region for detecting the transmission spectrum of the sample.

16. The spectrophotometer according to claim 10, wherein the first light source is a halogen lamp for a visible region and the second light source is a deuterium lamp for a ultraviolet region.

17. A spectrophotometer comprising:
a first and a second light sources with mutually different emission spectral regions;
a sample cell;
detection optics that generate a transmission spectrum of a sample in the sample cell from a portion of light from the first and the second light sources that has passed through the sample cell;
light source monitoring optics that detect a portion of the light from the first and the second light sources that has not passed through the sample cell; and
an operation unit that corrects the transmission spectrum of the sample by using an output signal from the light source monitoring optics,
wherein:
the detection optics includes a polychromator that generates the transmission spectrum of the sample in the sample cell by dispersing the portion of the light from the first and the second light sources that has passed through the sample cell into a plurality of spectral components, and an image sensor that detects the transmission spectrum of the sample; and
the image sensor includes a pixel region used as a photodetector for the light source monitoring optics, and a pixel region for detecting the transmission spectrum of the sample.

18. The spectrophotometer according to claim 17, wherein the operation unit determines a transmission spectrum S′(λ, ti)(λ is wavelength) after correction according to the following expression:
S′(λ, ti)=S(λ, ti)/{(H(ti)+k×D(ti))/(H(0)+k×D(0))} (3)
where: H(0) and H(ti) are the emission intensity of the first light source and D(0) and D(ti) are the emission intensity of the second light source at time t=0 and t=ti (i=1, 2, 3, . . . ), respectively; S(λ, ti) is the transmission spectrum of the sample at time t=ti (i=1, 2, 3, . . . ); and k is the ratio of the amount of light from the first light source and the amount of light from the second light source.

19. The spectrophotometer according to claim 17, wherein a reference transmission spectrum is acquired by the polychromator at time t=0 without a sample stored in the sample cell, and the transmission spectrum of the sample S(λ, ti)(λ is wavelength) at time t=ti (i=1, 2, 3, . . . ) is corrected by using the reference transmission spectrum.

20. The spectrophotometer according to claim 17, wherein:
the light source monitoring optics include a first optical fiber that takes in light from the first light source and a second optical fiber that takes in light from the second light source; and
the light taken in by the first and the second optical fibers is guided to the pixel region used as the photodetector for the light source monitoring optics of the image sensor.
